(19) United States
(12) Patent Application Publication
(10) Pub. No.: US 2014/0279308 A1
(43) Pub. Date: Sep. 18, 2014

(54) EXPENSE INFORMATION MANAGEMENT METHOD, EXPENSE INFORMATION MANAGEMENT SYSTEM, AND MOBILE TERMINAL

(71) Applicant: MIROKU JYOHO SERVICE CO., LTD., Tokyo (JP)

(72) Inventor: Kiyoshi Ogawa, Tokyo (JP)

(73) Assignee: MIROKU JYOHO SERVICE CO., LTD., Tokyo (JP)

(21) Appl. No.: 14/210,513

(22) Filed: Mar. 14, 2014

(30) Foreign Application Priority Data
Mar. 18, 2013 (JP) 2013-054522
Jan. 22, 2014 (JP) 2014-009238

(51) Int. Cl. G06Q 40/00

(52) U.S. Cl. CPC G06Q 40/12
USPC 705/30

(57) ABSTRACT

The expense information management method contains acquiring expense information including a plurality of pieces of input information showing contents of an expense, determining whether or not a purpose type showing a purpose of the expense is a first type based on at least one piece of input information among the plurality of pieces of input information, storing the expense information corresponding to the expenses determined to be the first type in a first storage unit, and storing the expense information corresponding to the expenses determined not to be the first type in a second storage unit that is different from the first storage unit.

### CROSS-REFERENCE TO RELATED APPLICATIONS

The present application claims priority to Japanese Patent Applications number 2013-54522, filed on Mar. 18, 2013, and number 2014-9238, filed on Jan. 22, 2014. The contents of these applications are incorporated herein by reference in their entirety.

### BACKGROUND OF THE INVENTION

The present disclosure relates to an expense information management method, an expense information management system, and a mobile terminal. The present disclosure especially relates to an expense information management method, an expense information management system, and a mobile terminal for managing expense information.

Conventionally, JP 2009-104469 discloses a method of transmitting accounting information such as transportation expenses stored in an IC card built in a mobile terminal to a server that processes accounting information. By bringing the mobile terminal with a built-in IC card close to a card reader installed in an entrance gate of a station or a cash register of a shop, the expense information such as transportation expenses and product purchase expenses of the mobile terminal's user is recorded in the IC card.

Quite a few stores where the user purchases products and services have no card reader installed. When the user purchases products and services in a shop without the card reader, the user has to input the expense information by operating the mobile terminal.

However, since there are size constraints on the mobile terminal, a keyboard, such as used for a stationary computer, is not provided. Therefore, there is a problem that it is time-consuming and difficult to input expense information with the mobile terminal. Further, it is difficult not only to input the expense information but also to appropriately process the expense information according to the type of inputted information.

For example, as expenses, there can be a company expense that relates to operations of a company, and a personal expense for private use. However, with the mobile terminal, it is difficult to input types of expense information such as company or personal expenses easily, to process inputted expense information appropriate for each of company expense information and private expense information, and to output expense information for processing in another accounting terminal in accordance with the type of information.

### BRIEF SUMMARY OF THE INVENTION

Therefore, in one aspect of the innovation included herein, an expense information management method, a mobile terminal, and an expense information management system for solving the above problems are provided. According to the first aspect of the present disclosure, the expense information management method that contains acquiring expense information including a plurality of pieces of input information showing contents of expenses, determining whether or not a purpose type showing a purpose of an expense is a first type, based on at least one piece of input information among the plurality of pieces of input information, storing expense information corresponding to the expense determined to be the first type in a first storage unit, and storing the expense information corresponding to the expense determined not to be the first type in a second storage unit that is different from the first storage unit is provided.

In the second aspect of the present disclosure, the expense information management system that contains a mobile terminal, and an expense information management apparatus that can communicate with the mobile terminal, wherein the mobile terminal includes an expense information acquisition unit that acquires the expense information including a plurality of pieces of input information showing contents of an expense, a determination unit that determines whether or not a purpose type showing a type of a purpose of the expense is the first type purpose based on at least one piece of input information among the plurality of pieces of input information, and a storage control unit that stores first expense information showing the expense information corresponding to the expense determined to be the first type in a first storage in the expense information management apparatus, and stores the expense information corresponding to the expense determined not to be the first type in a second storage unit of the mobile terminal that is different from the first storage unit, and wherein the expense information management apparatus includes an acquisition unit that acquires the first expense information from the mobile terminal, and a journal unit that journalizes the first expense information acquired by the acquisition unit is provided.

In the third aspect of the present disclosure, the mobile terminal that contains an expense information acquisition unit that acquires the expense information including a plurality of pieces of input information showing contents of an expense, a determination unit that determines whether or not a purpose type showing the type of purpose of the expense is a first type, based on at least one piece of input information among the plurality of pieces of input information, and a storage control unit that stores the expense information corresponding to the expense determined to be the first type in a first storage unit, and stores the expense information corresponding to the expenses determined not to be the first type in a second storage unit that is different from the first storage unit is provided.

The summary of the invention described above does not list all necessary features of the present invention and sub-combinations of these features can also constitute the invention.

### BRIEF DESCRIPTION OF THE DRAWINGS

FIG. 1 shows a configuration of an expense information management system of the first embodiment.

FIG. 2 shows an example of determination reference information according to the first embodiment.

FIG. 3 shows an example of an input screen of the mobile terminal in the first embodiment.

FIG. 4 shows an example of a flowchart of an operation of an output portion outputting output information according to the first embodiment.

FIG. 5 shows a configuration example of the mobile terminal according to the second embodiment.

FIG. 6 shows a configuration example of the mobile terminal according to the third embodiment.

FIG. 7 shows a configuration example of the mobile terminal according to the fifth embodiment.

FIG. 8 shows a configuration example of the mobile terminal according to the sixth embodiment.

FIG. 9 shows a configuration example of the mobile terminal according to the seventh embodiment.

FIG. 10 shows an example of an input screen of the mobile terminal according to the seventh embodiment.

FIG. 11 shows an aggregated result of expenses for each piece of the tag information according to the seventh embodiment.

FIG. 12 shows a configuration of the mobile terminal according to the eighth embodiment.

FIG. 13 shows an example of an income/expenditure information confirmation screen in the eighth embodiment.

FIG. 14 shows an example of a balance adjustment screen according to the eighth embodiment.

FIG. 15 shows an example of an income/expenditure history list screen according to the eighth embodiment.

FIG. 16 shows a configuration of the mobile terminal according to the ninth embodiment.

FIG. 17 shows an example of an income/expenditure information confirmation screen according to the ninth embodiment.

FIG. 18 shows an example of an uncompleted input list screen according to the ninth embodiment.

FIG. 19 shows a configuration of the expense information management system of the tenth embodiment.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### The First Embodiment

### Summary of an Expense Management Information System S

FIG. 1 shows a configuration of an expense information management system S according to the first embodiment. The expense information management system S includes a mobile terminal 1 and an expense information management apparatus 2. The mobile terminal 1 and the expense information management apparatus 2 can communicate data with each other via a network 3. The network 3 is, for example, the Internet or a local area network.

The expense information management system S may include a server 4 connected to the network 3. The server 4 stores data received from the mobile terminal 1 and transmits the stored data to the expense information management apparatus 2.

For example, the mobile terminal 1 is a communication terminal such as a cellular phone, a smart phone, or a tablet apparatus. The mobile terminal 1 acquires expense information that is information about products and services that the user of the mobile terminal 1 purchased by spending money, and transmits the acquired expense information to the expense information management apparatus 2. The expense information management apparatus 2 manages the expense information received from the mobile terminal 1 as accounting information. The expense information management apparatus 2 is, for example, a computer that manages accounting information. The expense information herein includes, for example, information showing a name of a product or a service, a purchase price, and a purchase date.

### [Configuration Example of the Mobile Terminal 1]

The mobile terminal 1 includes a control unit 11, an operation unit 12, a display unit 13, a storage unit 14 as a second storage unit, and a communication unit 15.

The control unit 11 is, for example, a microprocessor executing a program for a mobile terminal. The control unit 11 controls the operation unit 12, the display unit 13, the storage unit 14, and the communication unit 15 by executing the program for the mobile terminal.

The operation unit 12 is, for example, a touch panel or a button that is provided to overlap the display unit 13 of the mobile terminal 1. The operation unit 12 accepts an input operation from the user of the mobile terminal 1 under the control of the control unit 11. For example, the operation unit 12 accepts an input operation when the user of the mobile terminal 1 touches the screen displayed on the display unit 13. The operation unit 12 may be a microphone and may accept an input operation through a voice input from the user.

The display unit 13 is, for example, a liquid crystal display. The display unit 13 displays characters and images under the control of the control unit 11.

The display unit 13 displays, for example, an input screen for the user to input the expense information and displays the expense information inputted by the user.

The storage unit 14 includes a nonvolatile memory for storing the program for the mobile terminal, and a volatile memory for temporarily storing various data. The storage unit 14 may include a storage medium such as an insertable/removable memory card.

The communication unit 15 is a wireless module that performs wireless communication with a base station of a mobile phone network. The data transmitted to the base station from the communication unit 15 is transmitted to the expense information management apparatus 2 via the network 3. The communication unit 15 may be a wired communication interface directly connected to the expense information management apparatus 2.

The function of the control unit 11 is described in detail below.

The control unit 11 functions as an expense information acquisition unit 111, a determination unit 112, a storage control unit 113, an extraction unit 114, an output unit 115, a display control unit 116, and a reference-information acquisition unit 117 by executing the program for the mobile terminal stored in the storage unit 14.

As the operation unit 12 accepts an operation to input expense information of the user of the mobile terminal 1, the expense information acquisition unit 111 acquires the expense information including a plurality of pieces of input information showing contents of the expense. That is, the expense information is configured by including input information associated with each of the plurality of input items. The user of the mobile terminal 1 inputs a name of a product purchased, a purchase price, a shop name where a commodity was purchased, an expense item (category), and the like of a purchased commodity to the plurality of input items as input information.

The input items are, for example, a name of a product or a service, a price, a shop name, an expense item, a purpose type, date, and the like. The expense item includes category information such as social expenses and transportation expenses used for journaling in an accounting process in the expense information management apparatus 2. The purpose type is information showing a type of a purpose of a user's expenditure which is determined by the determination unit 112 or selected by the user. For instance, there are a plurality of purpose types such as a purpose for operations of a company and a purpose for the user. There are purpose types of “company” and “personal” herein. The purpose type “company” is also referred to as the first type and the purpose type “personal” is also referred to as the second type.

The determination unit 112 determines whether or not the purpose type is the first type based on at least one piece of the input information among the plurality of pieces of input information. Specifically, the determination unit 112 determines whether the purpose type of the expenditure is the first type or the second type based on determination reference information for determining the purpose type.

FIG. 2 shows an example of determination reference information according to the first embodiment. As shown in FIG. 2, the determination reference information including a selection item showing input items selected by the user, a priority of the selection items, input information, and a purpose type are stored in the storage unit 14 in association with each other.

For example, in the determination reference information shown in FIG. 2, the purpose type “company” is associated with input information “Tanaka stationery shop” of the input item “shop name,” and the purpose type “personal” is associated with the input information “Barber Sato.” The purpose type “company” is associated with the input information “slip paper” of the input item “product or service name,” and the purpose type “personal” is associated with the input information “rice.”

The determination unit 112 identifies the input information used for determining the purpose type by referencing determination reference information preset by the user and stored in the storage unit 14. The determination unit 112 determines whether or not input information included in expense information matches the input information stored in determination reference information in order from the selection item with the highest priority in the determination reference information. When the determination unit 112 determines that both pieces of information match each other, the determination unit 112 determines that a purpose type associated with the input information is the purpose type corresponding to the expense information.

For example, as shown in FIG. 2, if the “shop name” is set as the first priority of the selection item information and “Tanaka stationery shop” is inputted as the input information to an input item “shop name” included in the acquired expense information, the determination unit 112 determines that the purpose type of the expense information is “company.”

If the input information included in the expense information does not match the input information stored in the determination reference information, the determination unit 112 determines the purpose type based on the selection item with the next highest priority. That is, if the determination unit cannot determine the purpose type only with input information corresponding to the selection item with the highest priority, the determination unit 112 determines the purpose type based on the input information corresponding to the selection item with the next highest priority.

The storage control unit 113 controls reading and writing of data in the storage unit 14 and in a storage unit 21 in the expense information management apparatus 2. The storage control unit 113 stores expense information corresponding to an expense determined to be the first type in the storage unit 21 via the communication unit 15, and stores expense information corresponding to an expense determined not to be the first type in the storage unit 14, which is different from the storage unit 21.

Specifically, the storage control unit 113 first stores all expense information in the storage unit 14. Here, the storage unit 113 stores expense information including a purpose type determined by the determination unit 112 in the storage unit 14. The storage control unit 113 stores expense information whose purpose type is “company” in the storage unit 21 by making the extraction unit 114 extract the expense information whose purpose type is “company” and then making the output unit 115 output the extracted information. The storage control unit 113 may store the expense information in the server 4 via the communication unit 15 instead of storing the expense information in the storage unit 21.

The storage control unit 113, for example, stores expense information whose purpose type is “company” in the storage unit 21 according to an operation of the user. If a date for storing expense information in the storage unit 21 is preset, the storage control unit 113 stores expense information in the storage unit 21 on the preset date. For example, if the date is set to be the end of the month, the storage control unit 113 makes the extraction unit 114 extract the expense information whose purpose type is “company” which has been stored in the storage unit 14 during a one month period from when the expense information was previously stored in the storage unit 21, and then stores the extracted information in the storage unit 21. If the date for storing the expense information in the storage unit 21 is set to be the end of the day, the storage control unit 113 may read a plurality of pieces of expense information whose purpose type is “company” inputted in a day and temporarily stored in the storage unit 14, and then store the read information in the storage unit 21 at the end of the day (e.g. at midnight).

The storage control unit 113 may read expense information stored in the storage unit 21 and return the expense information to the storage unit 14 according to an operation of the user. Thus, for example, the mobile terminal 1 can prevent the expense information from being settled as expenses of a company when the user changes the purpose type from “company” to “personal.”

The extraction unit 114 extracts expense information whose purpose type is the first type as the first expense information from the storage unit 14. The extraction unit 114 may extract the expense information whose purpose type is the second type as the second expense information from the storage unit 14.

The output unit 115 outputs a file of the first file type including the first expense information extracted by the extraction unit 114. The output unit 115, for example, stores the first expense information associated with the first purpose type expense in a file of the first file type and transmits it to the expense information management apparatus 2. When the output unit 115 stores the expense information in the file, the output unit 115 may classify the information into expense items that are used in a company to manage accounting information.

The first file type is a file type used in the expense information management apparatus 2. The output unit 115 may output a file of the second file type including the second expense information. For example, the output unit 115 stores the second expense information associated with personal expenses in a file of the second file type used by software that manages household accounts of the user of the mobile terminal 1, and transmits the second expense information to the user's computer. The second file type is a file type used for software that manages household accounts. The output unit 115 may store the second expense information in the storage unit 14 with a predetermined file type.

The configuration of data in the file, e.g. the type of data contained in the file, a data classification method, and the order of data in the file, is defined according to the “file type.” The “file type” includes a file format such as “csv” or “xls.” For example, the file type of the file including the first expense information may differ from the file type of the file including the second expense information.

The display control unit 116 displays characters and images on the display unit 13. The display control unit 116 displays the input items which are used for the determination unit 112 to determine a purpose type on the display unit 13 as a plurality of candidates among the plurality of input items corresponding to the plurality of pieces of input information. That is, the display control unit 116 displays the input items that can be used for the determination unit 112 to determine a purpose type on the display unit 13 as a plurality of candidates. Specifically, the display control unit 116 displays the input items such as “product or service name,” “shop name,” “purchase price,” “purchase date,” and “purchase place,” whose trend may differ between a company's expense and a personal expense, on the display unit 13 as the plurality of candidates.

The reference information acquisition unit 117 acquires a selected candidate as selection item information selected from among the plurality of candidates that have been displayed on the display unit 13 by the display control unit 116 according to an operation of the user with the operation unit 12, and also acquires a priority order corresponding to the selection item, input information corresponding to the selection item, and a purpose type corresponding to the selection item and the input information selected by the user. When the reference information acquisition unit 117 acquires the selection item information, the priority order, the input information, and the purpose type, the storage control unit 113 stores the selection item information, the priority order, the input information, and the purpose type in association with each other in the storage unit 14 as determination reference information.

### [A Configuration Example of an Expense Information Control Apparatus 2]

A configuration of the expense information control apparatus 2 is described below.

The expense information control apparatus 2 includes a storage unit 21 as a first storage unit and a control unit 22.

The storage unit 21 includes, for example, a nonvolatile memory, and a volatile memory for temporarily storing various data. The storage unit 21 stores an expense information control program. The storage unit 21 may be a storage medium such as an insertable/removable memory card or an optical disc.

The control unit 22 functions as an acquisition unit 221 and a journal unit 222 by executing the expense information management program stored in the expense information management apparatus 2. The acquisition unit 221 receives the first expense information of the first file type to acquire from the mobile terminal 1. The first file type is the format that can be processed in the expense information management program.

The journal unit 222 journalizes the first expense information acquired by the acquisition unit 221. Specifically, the journal unit 222 performs classification to journalize the first expense information into account titles of a balance sheet based on input information whose input item is the “expense item” (e.g., office supplies expenses, transportation expenses, communication expenses, entertainment, and social expenses) included in the first expense information.

### [An Expense Information Input Screen of the Mobile Terminal 1]

FIG. 3 shows an example of an expense information input screen of the mobile terminal 1 in the present embodiment. The details of the screen of the mobile terminal 1 when the user of the mobile terminal 1 inputs expense information are described, referring to FIG. 3.

The display unit 13 shown in FIG. 3 has tabs “expenditure” and “income.” When the user of the mobile terminal 1 taps the “expenditure” tab, a screen for inputting expense information is displayed. A case in which the “expenditure” tab is selected is described below.

The amount paid for a commodity or a service purchased by the user of the mobile terminal 1 is inputted in an input field of the input item “money amount.” When the user taps the input field of “money amount,” a screen in which the user can input the amount of money paid is displayed.

A purchase date is inputted in an input field of the input item “date.” When the user taps the input field of “date,” a screen in which the user can input the purchase date is displayed. The display control unit 116 may first display a present date in the “date” field, and then the user can change the date. For example, the display control unit 116 may display the present date information acquired from a clock built in the mobile terminal 1 in the “date” field when an amount of money is inputted in the “money amount” field.

In the input field of the input item “product name,” a name of a commodity or a service the user purchased is inputted. In the input field of the input item “shop name,” a name of a shop where the user purchased a commodity or a service is inputted. In the input field of an input item “expense item,” an expense item that shows a type of expenses is inputted.

In the input field of the input item “company or personal,” the user can select a type of expense purpose which the determination unit 112 determines. When the determination unit 112 determines that an expense that occurred is a company's expense based on at least one piece of information inputted in the “money amount” field, the “date” field, the “product name” field, the “shop name” field, and the “expense item” field, the “company” is displayed in a thick color and “personal” is paled. The user can select company or personal by himself/herself regardless of the determination result of the determination unit 112.

In the input field of the input item “payment method,” the user can select the method he/she used for payment, such as cash, a credit card, or a transfer.

An “output 1” button and an “output 2” button are located at the lower portion of the display unit 13. Expense information can be transmitted to a predetermined destination when the user of the mobile terminal 1 presses one of these buttons. For example, the user can transmit “company's” expense information inputted during a predetermined period to the expense information control apparatus 2 by tapping the “output 1” field. The user can transmit “personal” expense information inputted during a predetermined period to a personal terminal of the user by tapping the “output 2” field.

An “input” button, a “save” button, and a “history” button are located at the lowest portion of the display unit 13. When the user of the mobile terminal 1 taps the “input” button, expense information is put in a state enabling input. When the user taps the “save” button, displayed expense information is stored in the storage unit 14. When the user taps the “history” button, expense information inputted in the past becomes browsable and editable by suspending the input of expense information that the user has been doing. The input information that has been inputted by the user of the mobile terminal 1 is temporarily saved in the storage unit 14 as input information under a certain edition.

### [Flowcharts of the Operations]

FIG. 4 shows an example of a flowchart of the operation of the output unit 115 of the present embodiment outputting output information. The process of handling expense information from being inputted by the user to outputting it is described below referring to FIGS. 3 and 4. In this example, determination reference information includes the information shown in FIG. 2.

Firstly, the expense information acquisition unit 111 acquires expense information including a plurality of pieces of input information the user inputted by using the operation unit 12 (S1). In the example shown in FIG. 3, the expense information acquisition unit 111 acquires expense information of “money amount=200 yen,” “date=Feb. 22, 2013,” “product name=slip paper,” “shop name=Tanaka stationery shop,” and “expense item=office supplies.”

Next, the determination unit 112 identifies a selection item based on determination reference information stored in the storage unit 14 (S2). Specifically, the determination unit 112 first identifies a selection item with the highest priority among a plurality of selection items included in the determination reference information. In the example shown in FIG. 3, the determination unit 112 identifies the “shop name” as the selection item.

Then, the determination unit 112 identifies a purpose type based on the input information associated with the selection item in the determination reference information (S3). The determination unit 112 determines whether or not the input information associated with the identified selection item matches the input information of the input item corresponding to the selection item included in the expense information in the determination reference information. When the determination unit 112 determines that the information matches, the determination unit 112 identifies a purpose type associated with the input information to be the purpose type of the expense information. The identified purpose type is to be associated with the expense information. When the input information of the information item “shop name” is “Tanaka stationery shop” in the expense information, such as shown in FIG. 3, the determination unit 112 determines the purpose type to be “company” since the input information of the expense information matches the selection item “shop name” included in the determination reference information and the input information “Tanaka stationery shop” associated with the purpose type “company.”

The determination unit 112 then determines whether or not the purpose type has been determined (S4). When the purpose type has been determined, which means the determination is “Yes,” the determination unit 112 proceeds to step S5. When the purpose type cannot be determined because the input information acquired by the expense information acquisition unit 111 is not included in the determination reference information, which means the determination is “No,” the determination unit 112 proceeds to step S2 and identifies a selection item with the next highest priority.

Next, the storage control unit 113 stores the acquired expense information in the storage unit 14 (S5). Among the plurality of acquired pieces of expense information, the determination unit 112 transmits the first expense information whose purpose type is the first type (company) to the expense information control apparatus 2 (S6) via the output unit 115.

As described above, the mobile terminal 1 according to the present embodiment determines whether or not the purpose type showing a type of a purpose of expenses is the first type based on at least one piece of input information among a plurality of pieces of information showing the contents of expenses and outputs a file of the first file type including the first expense information corresponding to the first file type. The mobile terminal 1 can extract company's expenses according to the contents of expenses inputted by the user and outputs the company's expenses as a file of a fixed file type. As a result, the user may use the mobile terminal 1 to easily generate data used for the company's accounting processing. The user can unitarily manage expense information of each of the plurality of purpose types whether or not the expenses are for a company or private by using one mobile terminal 1.

### The Second Embodiment

### Display Expense Information Based on Position Information

FIG. 5 shows a configuration example of the mobile terminal 1 according to the second embodiment. The mobile terminal 1 according to the present embodiment is the same as the mobile terminal 1 shown in FIG. 1 except that the mobile terminal 1 according to the present embodiment further comprises a position information acquisition unit 118.

The position information acquisition unit 118 acquires, for example, latitude and longitude information calculated based on data included in radio waves transmitted from GPS satellites as position information from a GPS receiver built in the mobile terminal 1 (not shown). For example, when the expense information acquisition unit 111 acquires expense information, the position information acquisition unit 118 acquires the position information showing the position where the expense information is acquired. The position information acquisition unit 118 may transmit the data included in the radio waves transmitted from the GPS satellites received by the mobile terminal 1 to a position calculation apparatus provided in an external apparatus and acquire the position information by receiving position information calculated by the position calculation apparatus.

When the storage control unit 113 stores the expense information acquired by the expense information acquisition unit 111 in the storage unit 14, the storage control unit 113 stores the expense information in the storage unit 14 in association with the position information acquired by the position information acquisition unit 118. Specifically, when the expense information acquisition unit 111 acquires the expense information and the purpose type is specified by the determination unit 112 or by hand, the storage control unit 113 stores the position information acquired by the position information acquisition unit 118 at that time and the expense information including the purpose type in the storage unit 14 in association with each other.

When the expense information acquisition unit 111 acquires at least one of a plurality of pieces of input information, the display control unit 116 displays expense information which includes the acquired input information and is associated with the position information identical to the position information acquired by the position information acquisition unit 118 at the time of acquiring the input information from among the expense information stored in the storage unit 14 on the display unit 13. For example, when the expense information acquisition unit 111 acquires input information “200 yen” corresponding to the input item “money amount” of the input information, the position information acquisition unit 118 acquires position information which shows the position where the input information was acquired. Among the expense information stored in the storage unit 14, the display control unit 116 reads expense information associated with the position information acquired by the position information acquisition unit 118 and whose input information of the input item “money amount” is “200 yen” from the storage unit 14. The display control unit 116 displays an input screen whose input information corresponding to the uncompleted input item is filled with the input information of the read expense information on the display unit 13.

Specifically, if there is a commodity purchased for “200 yen” in the past at the shop located at a position indicated by the position information acquired by the position information acquisition unit 118, the display control unit 116 displays the input information of the expense information corresponding to the commodity on the display unit 13. The display control unit 116 displays the date when the expense information acquisition unit 111 acquired the information of the amount of money as the input information in the input field of the input item “date.” When the user taps the “save” button in this status, the storage control unit 113 stores the displayed expense information in the storage unit 14.

If the user of the mobile terminal 1 has purchased commodities for “200 yen” in the past at the shop located at the position indicated by the position information, and if the storage unit 14 stores a plurality of pieces of expense information corresponding to the commodities, the display control unit 116 displays information of a plurality of product names included in a plurality of pieces of expense information on an auxiliary screen of the input screen. When the plurality of product names are displayed on the display section 13, the user of the mobile terminal 1 selects a name of a product whose expense information should be inputted from among the plurality of product names. The display control unit 116 reads the expense information corresponding to the commodity selected by the user from the storage unit 14, and displays input information included in the expense information filled in input fields of each input item on the input screen. Even when the expense information does not match the amount of expense acquired by the information acquisition unit 111, the display control unit 116 may display the expense information of commodities which have been purchased for an amount of money within a predetermined range with respect to the amount of money acquired by the expense information acquisition unit 111.

As described above, if the expense information acquisition unit 111 acquires at least one piece of input information when money has been spent in the past in the same shop, the display control unit 116 displays the expense information including the input information identical to the acquired input information on the display unit 13. Thus, the user can reduce the time needed for inputting new expense information.

When the position information acquired by the position information acquisition unit 118 shows the same position longer than a predetermined time, the display control unit 116 may display at least one of the plurality of pieces of input information stored in the storage unit 14 in association with the position information on the display unit 13. Specifically, when the user stays longer than the predetermined time at the position indicated by the position information acquired by the position information acquisition unit 118, the display control unit 116 displays a shop name or a product name included in the expense information stored in the storage unit 14 in association with the position information on the display unit 13. The predetermined time herein is a time required for the user of the mobile terminal 1 to pass through a shop, for instance. When the user stays longer than the predetermined time at the same position, the user possibly receives a service or purchases a commodity at the shop. Therefore, displaying expense information related to a commodity purchased in the past at the shop corresponding to the position information enables the user to reduce the time needed for inputting new expense information.

Similarly, when the position information acquired by the position information acquisition unit 118 shows the same position longer than the predetermined time, the display control unit 116 may display at least one shop name corresponding to the position information on the display unit 13 as one of the pieces of input information. For example, the display control unit 116 accesses an external database which stores shop names and position information in association with each other via a communication unit 15, acquires shop names of the shops around the position corresponding to the position information, and displays the acquired shop names on the display unit 13. When the storage unit 14 stores the shop names and the position information in association with each other, the display control unit 116 may access the storage unit 14, acquire the shop name corresponding to the position information, and display the acquired shop name on the display unit 13.

Based on the position information, the display control unit 116 may display a plurality of pieces of expense information generated in the past at the store located at the position indicated by the position information on the display unit 13. For example, by displaying a plurality of product names included in each of the plurality of pieces of expense information on the auxiliary screen of the input screen, the display control unit 116 displays these product names on the display unit 13.

When the plurality of product names are displayed on the display unit 13, the user of the mobile terminal 1 can select a name of a product, for which expense information is inputted, from among the plurality of product names. The display control unit 116 displays expense information corresponding to the selected product name. The user stores the expense information by tapping the save button while the expense information is displayed. The mobile terminal 1 displays expense information associated with position information based on position information acquired by the position information acquisition unit 118, and therefore the user of the mobile terminal 1 can reduce the time needed for inputting expense information.

When the display control unit 116 displays a plurality of pieces of input information stored in the storage unit 14 in association with the position information acquired by the position information acquisition unit 118 on the display unit 13, the display control unit 116 may display only the second expense information whose purpose is private. Because the first expense information, whose purpose is for a company, is treated as a company's accounting information, accurate inputs of each piece of input information are required. On the other hand, because the second expense information, whose purpose is private, is used for managing pocket money and a household account, and its purpose is to grasp an outline of the income and expenditure, saving the time and effort for input has higher priority than the accuracy of the input.

As described above, the mobile terminal 1 according to the present embodiment acquires the position information showing the position where the expense information acquisition unit 111 acquires the expense information, and displays at least one piece of input information from among the plurality of pieces of input information associated with the position information on the display unit 13. As a result, the user can reduce the time needed for inputting expense information since the expense information can be inputted by using the displayed input information.

### The Third Embodiment

### Display Expense Information Based on a Predicted Date of Occurrence of Expenses

FIG. 6 shows a configuration example of the mobile terminal 1 according to the third embodiment. The mobile terminal 1 according to the present embodiment is the same as the mobile terminal 1 shown in FIG. 1 according to the first embodiment except that the mobile terminal 1 according to the present embodiment further comprises an expense prediction unit 119.

The expense prediction unit 119 operates once a week to calculate a predicted date of expense, for instance. Specifically, the expense prediction unit 119 calculates the predicted date of expense, which is when money is expected to be spent, based on date information included in periodic expense information that periodically occurred among a plurality of pieces of expense information stored in the storage unit 14.

The storage control unit 113 stores the predicted date of expense and the periodic expense information in the storage unit 14 in association with each other.

When at least one of a plurality of pieces of information acquired by the expense information acquisition unit 111 within a predetermined period around the predicted date of expense calculated by the expense prediction unit 119 matches at least one of a plurality of pieces of information of the periodic expense information, the display control unit 116 displays the plurality of pieces of input information of the periodic expense information stored in the storage unit 14 in association with the predicted date of expense on the display unit 13.

For example, suppose that the storage unit 14 stores periodic expense information showing that a “subscription fee” of “4,000 yen” was spent for the newspaper “Daily XYZ” on “Jan. 20, 2013,” “Feb. 20, 2013,” and “Mar. 20, 2013.” When the expense information acquisition unit 111 acquires information showing the price of “4,000 yen” on “Apr. 20, 2013,” the display control unit 116 displays the product name as “subscription fee” and the shop name as “Daily XYZ.” When the user taps the “save” button, the storage control unit 113 stores the displayed expense information in the storage unit 14.

As described above, the mobile terminal 1 according to the present embodiment calculates a predicted date of expense based on input information of periodic expense information and displays a plurality of pieces of the input information of the periodic expense information on the display unit 13 when at least one of the plurality of pieces of input information of expense information acquired by the expense information acquisition unit 111 within a predetermined period around the predicted date of expense matches at least one of the plurality of pieces of input information of the periodic expense information. As a result, the user can reduce the time needed for inputting expense information since expense information can be inputted by selecting at least one piece of input information.

### The Fourth Embodiment

### Display Expense Information Based on a Scheduled Period of Occurrence of Expenses

The mobile terminal 1 according to the present embodiment is the same as the mobile terminal 1 shown in the first embodiment except that the mobile terminal 1 according to the present embodiment displays expense information based on a scheduled date of expense.

The display control unit 116 displays an input screen of the periodic expense information on the display unit 13 according to an input operation of the periodic expense information through the operation unit 12.

The storage control unit 113 stores the expense information showing expenses that periodically occur and a scheduled period of the expenses in association with each other in the storage unit 14 as periodic expense information.

When the expense information acquisition unit 111 acquires at least one of the plurality of pieces of input information, the display control unit 116 displays a plurality of pieces of input information included in the expense information associated with the periodic expense information, if (i) the periodic expense information stored in the storage unit 14 includes the acquired input information, and (ii) the time of inputting the input information is within a scheduled period included in the periodic expense information.

For example, suppose that periodic expense information showing that the “subscription fee” of “4,000 yen” is spent for the newspaper “Daily XYZ” is inputted through the operation unit 12 on “the 20th of each month” and that this periodic expense information is stored in the storage unit 14. When the expense information acquisition unit 111 acquires information showing the money amount “4,000 yen” on “Apr. 20, 2013,” the display control unit 116 displays the product name as “subscription fee” and the shop name as “Daily XYZ.” When the user taps the “save” button, the storage control unit 113 stores the displayed expense information in the storage unit 14.

As described above, with the mobile terminal 1 according to the present embodiment, the user can reduce the time needed for inputting expense information since expense information can be inputted based on periodic expense information inputted by the user of the mobile terminal 1.

### The Fifth Embodiment

### Display Expense Information Based on a Predicted Date of Occurrence of Expense and Position Information

FIG. 7 shows a configuration example of the mobile terminal 1 according to the fifth embodiment. The mobile terminal 1 according to the present embodiment is the same as the mobile terminal 1 shown in FIG. 5 according to the second embodiment except that the mobile terminal 1 according to the present embodiment further comprises the expense prediction unit 119.

When the storage control unit 113 according to the present embodiment stores the expense information acquired by the expense information acquisition unit 111 in the storage unit 14, the storage control unit 113 stores the expense information in the storage unit 14 in association with the position information acquired by the position information acquisition unit 118. For example, when the input information of the input item “date” of the expense information to be stored is “Feb. 28, 2013,” the input information of the input item “shop name” of the expense information to be stored is “Barber Sato,” the input information of the input item “product or service name” of the expense information to be stored is “barber fee,” and the input information of the input item “money amount” of the expense information to be stored is “5,000 yen,” the storage control unit 113 stores this information in the storage unit 14 in association with the position information.

The expense prediction unit 119 calculates a predicted date of expense, which is when money is expected to be spent, based on date information included in the input information of the periodic expense information showing the expense information that periodically occurred, among the plurality of pieces of expense information stored in the storage unit 14. Specifically, the expense prediction unit 119 determines that the expense information whose “expense item” is fuel and lighting expenses and the expense information whose input information of the input item “product or service name” is “barber fee” is periodic expense information. Then the expense prediction unit 119 calculates the predicted date of expense when the same expense will occur based on input information of the input item “date” included in the periodic expense information.

More specifically, the expense prediction unit 119 first extracts a plurality of pieces of expense information having all the same input information except for input information corresponding to the input item “date.” Next, the expense prediction unit 119 calculates intervals of occurrences of expense information based on the input information corresponding to the input item “date” of a plurality of the extracted pieces of expense information. When differences between each of a plurality of intervals are less than a predetermined value, the expense prediction unit 119 determines a mean value of the intervals to be an interval of occurrences of the expense information. The expense prediction unit 119 makes the date generated by adding the mean value to the input item “date” included in the latest expense information among the expense information be the predicted date of expense when the same expense information may occur.

For example, in a case where the storage unit 14 stores expense information showing that a “barber fee” of “5,000 yen” is spent at the “Barber Sato” on “Jan. 26, 2013,” “Feb. 28, 2013,” and “Apr. 1, 2013,” the expense prediction unit 119 determines that the expense occurs every month. The expense prediction unit 119 then calculates “Apr. 30, 2013” as a predicted date of expense. The storage control unit 113 stores the predicted date of expense, periodic expense information, and position information where the periodic expense information was generated in the storage unit 14 in association with each other.

When position information acquired by the position information acquisition unit 118 within a predetermined period around a predicted date of expense calculated by the expense prediction unit 119 matches position information associated with the predicted date of expense, the display control unit 116 displays a plurality of pieces of input information included in the periodic expense information stored in the storage unit 14 in association with the predicted date of expense and the position information on the display unit 13. For example, when position information acquired by the position information acquisition unit 118 during a period within a predetermined percentage (for example, ±10%) of the interval of occurrences of expenses used for calculating a predicted date of expense with respect to the predicted date of expense matches the position information stored in the storage unit 14 in association with the predicted date of expense, the display control unit 116 displays the money amount, the product name, the shop name, the expense item, and the purpose of the expense included in the periodic expense information stored in the storage unit 14 in association with the predicted date of expense and the position information.

Specifically, suppose that the position information acquisition unit 118 acquired position information showing the position of the “Barber Sato” on “Mar. 29, 2013” in the above example. Since “Mar. 29, 2013” is within three days of “Apr. 1, 2013,” which is the predicted date of expense calculated by the expense prediction unit 119, the display control unit 116 displays a “barber fee” and “5,000 yen” that are input information of the past periodic expense information used for calculating the predicted date of expense by the expense prediction unit 119 on the display unit 13. The user can save the expense information by tapping the save button when the displayed input information is correct.

As described above, with the mobile terminal 1 according to the present embodiment, the expense prediction unit 119 calculates a predicted date of expense when expenses will occur, based on date information included in periodic expense information. When the position of the mobile terminal 1 at a time within a predetermined period around the predicted date of expense matches the position corresponding to periodic expense information, the display control unit 116 displays a plurality of pieces of input information included in the periodic expense information on the display unit 13. As a result, the user can reduce the time needed for inputting expense information since expense information can be inputted by using the displayed input information.

### The Sixth Embodiment

### Acquiring Expense Information Based on a Voucher Image

FIG. 8 shows a configuration of the mobile terminal 1 according to the sixth embodiment. The mobile terminal 1 according to the present embodiment is the same as the mobile terminal 1 described in the first embodiment except that the mobile terminal 1 according to the present embodiment further comprises a photographing unit 16, a photographing control unit 120, and a conversion unit 121.

The photographing unit 16 comprises a lens, a charge-coupled device (CCD), and the like. According to a user's operation, the photographing unit 16 photographs a voucher (for example, a receipt), which is a certificate of expense information, under the control of the control unit 11. The photographing control unit 120 generates a voucher image by making the photographing unit 16 photograph a voucher.

The conversion unit 121 converts the voucher image generated by the photographing control unit 120 into character information. Specifically, the conversion unit 121 converts the readable information from the voucher image into character information. For example, the conversion unit 121 converts the shop name, the name of a purchased product, the money amount, the payment date, and the like included in the voucher into character information. When a certificate includes an image such as a two-dimensional bar code containing character information showing contents of the certificate, the conversion unit 121 may analyze the image and convert it into the character information.

The conversion unit 121 may convert a voucher image into character information by using an external apparatus (not shown) other than the mobile terminal 1. The conversion unit 121 may transmit a voucher image photographed by the photographing unit 16 to the external apparatus via the communication unit 15 and receive character information converted from the voucher image by the external apparatus.

Next, the expense information acquisition unit 111 acquires character information converted by the conversion unit 121 as input information. Specifically, the expense information acquisition unit 111 acquires the shop name, the name of a purchased product, the money amount, the payment date, and the like included in a voucher converted by the conversion unit 121 as input information.

Since expense information whose purpose type is the first type is treated similarly to company's accounting information, storing and submitting vouchers for the tax report is required. On the other hand, because the second type expense information, whose purpose is private, is mainly used for managing pocket money and a household account, and its purpose is to grasp an outline of the income and expenditure, vouchers are not required. Therefore, when the expense information acquisition unit 111 acquires character information converted by the conversion unit 121 as input information, the determination unit 112 determines that the purpose type of expense information corresponding to the input information is the first type. When the determination unit 112 determines that the purpose type of the expense information is the first type, the storage control unit 113 stores the expense information and the voucher image corresponding to the expense information in the storage unit 21.

A storage unit 14 may store selection information in advance for the determination unit 112 to select whether or not the determination unit 112 determines that the purpose type of expense information corresponding to character information converted by the conversion unit 121 is the first type. The determination unit 112 references the selection information stored in the storage unit 14, and determines the purpose type based on the character information in a case where the selection information shows that the purpose type should be determined based on the character information.

As described above, the mobile terminal 1 according to the present embodiment generates a voucher image by making the photographing unit 16 photograph a voucher, converts the image into character information, and determines that the purpose type of the expense information corresponding to the input information is the first type when the expense information acquisition unit 111 acquires character information converted by the conversion unit 121 as the input information. Therefore, the user can reduce the time needed for inputting expense information since expense information can be inputted by photographing a voucher image.

### The Seventh Embodiment

### Aggregate the Amount of Money for Each Tag Set in the Expense Information

The mobile terminal 1 according to the present embodiment is the same as the mobile terminal 1 shown in the first embodiment except that the mobile terminal 1 according to the present embodiment includes one or more pieces of tag information classifying contents of expenses as input information, and that the mobile terminal 1 displays the expense information based on the tag. FIG. 9 shows a configuration of the mobile terminal 1 in the present embodiment. The mobile terminal 1 of the present embodiment further comprises an aggregation unit 122. The aggregation unit 122 aggregates the amounts of money included in the expense information for each piece of tag information.

FIG. 10 shows an example of an input screen of the expense information of the mobile terminal 1 according to the present embodiment.

In addition to the input items shown in FIG. 3, the display unit 13 shown in FIG. 10 includes an input item “tag” for inputting tag information to classify contents of expenses. A plurality of pieces of information may be inputted to the input item “tag.”

In the present embodiment, when the user taps the “history” button, the user can view an aggregation result of expenses or income for each piece of tag information in addition to viewing and editing expense information inputted in the past. The user can select any of the monthly, weekly, and daily aggregation results and the aggregation result of any duration as an aggregation result of each piece of tag information. The aggregation unit 122 aggregates the amount of money included in expense information for each piece of tag information based on a condition selected by the user. FIG. 11 shows an aggregation result of expenses for each piece of tag information. The amount of expenses in December in 2013 for each piece of tag information can be seen on the display unit 13 shown in FIG. 11.

When a plurality of pieces of tag information are set to a single piece of expense information, the amount of money corresponding to the expense information for each piece of tag information is aggregated.

For example, two pieces of tag information “ramen” and “lunch” are set for the expense information shown in FIG. 10, and the amount of money corresponding to the expense information is reflected in an aggregation result of the tag information “ramen” and the aggregation result of the tag information “lunch.”

When tag information or the amount of expenses displayed in an aggregation result is selected via the operation unit 12, the display control unit 116 may display the selected tag information or a list of expense information with tag information corresponding to the selected amount of expenses on the display unit 13. For example, when tag information “lunch” or the amount of expense “13,650 yen” is selected, the display control unit 116 displays a list containing the date, the product name, and the money amount of the expense information for which “lunch” is set as tag information on the display unit 13.

As described above, with the mobile terminal 1 according to the present embodiment, the aggregation unit 122 aggregates the amount of money included in expense information for each piece of tag information. Thus, the user of the mobile terminal 1 can check expense information in a different perspective from expense items for managing accounting information, and a problem that the user was not able to check expense information for each item that the user personally wants to know by using the expense items for managing accounting information can be solved.

### The Eighth Embodiment

### Manage the Amount of the User's Money

The mobile terminal 1 according to the present embodiment is the same as the mobile terminal 1 shown in the first embodiment except that the mobile terminal 1 according to the present embodiment manages the amount of a user's money. FIG. 12 shows a configuration of the mobile terminal 1 according to the present embodiment. The mobile terminal 1 according to the present embodiment further comprises an accepting unit 123, an income/expenditure calculation unit 124, and an updating unit 125.

The accepting unit 123 accepts an input of the amount of a user's money by the user of the mobile terminal 1. Specifically, the display control unit 116 displays a screen for accepting an input of the amount of the user's money in response to accepting an operation of starting an input of the amount of the user's money via the operation unit 12. The accepting unit 123 then stores the amount of money inputted in the screen in the storage unit 14.

The income/expenditure calculation unit 124 calculates income and expenditure during a predetermined period (for example, a day, a week or a month) and stores the calculated income and expenditure in the storage unit 14. The income/expenditure calculation unit 124 may calculate a weekly income and expenditure by aggregating a plurality of daily income and expenditures or calculate a monthly income and expenditure by aggregating a plurality of weekly income and expenditures. When the income/expenditure calculation unit 124 calculates income and expenditure of a day, the updating unit 125 updates the amount of the user's money stored in the storage unit 14 based on the calculated income and expenditure. The display control unit 116 displays the income and expenditure on the display unit 13 when accepting an operation of the user to display the income and expenditure via the operation unit 12.

FIG. 13 shows an example of an income/expenditure information confirmation screen according to the present embodiment. In FIG. 13, income in December and expenses in December are displayed as income and expenditure of December along with the amount of the user's money. A balance adjustment button for adjusting the amount of the user's money is displayed on the income/expenditure information confirmation screen. When the balance adjustment button is pushed, the display control unit 116 displays a balance adjustment screen as shown in FIG. 14. An input field for inputting a corrected amount of balance, a registration button, and a back button are displayed on the balance adjustment screen. When the user inputs the current amount of the user's money in the input field for inputting the corrected amount of balance and pushes the registration button, the accepting unit 123 accepts the input of the amount of money of the user of the terminal.

The income/expenditure calculation unit 124 calculates the difference between the amount of the user's money that is newly accepted by the accepting unit 123 and the amount of the user's money updated by the updating unit 125 as adjusted unspecified money. The adjusted unspecified money occurs because of, for example, a shortage or an excess in the expense information.

A history button is displayed on each of the income/expenditure information confirmation screen shown in FIG. 13 and the balance adjustment screen shown in FIG. 14. The display control unit 116 displays an income/expenditure history list screen when the history button is pushed. FIG. 15 shows an example of the income/expenditure history list screen according to the present embodiment. As can be seen in FIG. 15, adjusted unspecified money is included in the expense information displayed on the income/expenditure history list screen. For example, when expense information corresponding to the adjusted unspecified money is selected via the operation unit 12, the display control unit 116 may display an expense information input screen to accept an input of expense information of adjusted unspecified money.

The display control unit 116 may display an analysis screen based on expense information. Specifically, an analysis button is displayed on the income/expenditure information confirmation screen shown in FIG. 13 and the balance adjustment screen shown in FIG. 14, and the display control unit 116 displays any of a plurality of analysis screens when the analysis button is pushed.

For example, the display control unit 116 displays changes in the amount of income and expenses.

The display control unit 116 also displays monthly or annual expense information for each expense item. Here, the display control unit 116 may display a pie chart of expense shares of each of the expense items.

The display control unit 116 displays an analysis screen showing achievements with respect to the target amount of expenses that is predetermined for each expense item. For example, the income/expenditure calculation unit 124 subtracts the actual amount of expenses from the target amount of money for each expense item and sets the result as a balance corresponding to each expense item, and the display control unit 116 may display the balance for each expense item.

The income/expenditure calculation unit 124 predicts the amount of the user's money in the future based on variations over time of the calculated income and expenditure. For example, the income/expenditure calculation unit 124 determines whether the income and expenditure are on an increasing trend or on a decreasing trend based on variations of the income and expenditure of each month, and predicts the amount of the user's money in the future from the determination result. The display control unit 116 displays an analysis screen showing the predicted amount of the user's money in the future.

The display control unit 116 displays a search screen of the expense information in the past. For example, on the search screen, the display control unit 116 may accept at least any one of the information from among a product name, a shop name, an expense item, tag information, and the like or a key word showing a part of the above information, a period, a money amount, and an expense item. The income/expenditure calculation unit 124 may search expense information based on the information accepted by the display control unit 116. For example, when a key word is accepted, the income/expenditure calculation unit 124 may search expense information including the key word accepted for any one of the product name, the shop name, the expense item, and the tag information. The income/expenditure calculation unit 124 may accept a selection of an item to be searched from among the product name, the shop name, the expense item, and the tag information, and may search for expense information including the accepted key word in the selected item.

As described above, the mobile terminal 1 according to the present embodiment accepts an input of an amount of the user's money and updates the amount of the user's money based on a calculated income and expenditure. Thus, the user can manage the amount of the user's money with the mobile terminal 1. The mobile terminal 1 calculates a difference between a newly accepted amount of the user's money and an updated amount of the user's money as adjusted unspecified money. Therefore, the user can grasp the adjusted unspecified money and can correct expense information of the amount of the unspecified money, and thereby the problem that the actual amount of the user's money becomes different from the amount of the user's money managed by the terminal 1 over time is solved, and the user can manage expenses accurately.

### The Ninth Embodiment

### Edit Uncompleted Expense Information

The mobile terminal 1 according to the present embodiment is the same as the mobile terminal 1 shown in the eighth embodiment except that the mobile terminal 1 according to the present embodiment acquires uncompleted expense information and is able to edit the uncompleted expense information. FIG. 16 shows a configuration of the mobile terminal 1 according to the present embodiment. The mobile terminal 1 according to the present embodiment further comprises an editing accepting unit 126.

According to the present embodiment, the income/expenditure information acquisition unit 111 acquires expense information including partial input information from among a plurality of pieces of input information (hereinafter referred to as “uncompleted expense information”). For example, the income/expenditure information acquisition unit 111 acquires at least any one of the money amount, the shop name, the product name, the date, and the expense item from among the input items. The income/expenditure information acquisition unit 111 may acquire sound data via a microphone (not shown) built in the mobile terminal 1 and image data via a photographing unit (now shown) from a user of the mobile terminal 1. The storage control unit 113 stores the uncompleted expense information acquired by the income/expenditure information acquisition unit 111 in the storage unit 14.

The display control unit 116 displays the number of pieces of the uncompleted expense information on the display unit 13. FIG. 17 shows an example of an income/expenditure information confirmation screen according to the present embodiment. As shown in FIG. 17, the number of pieces of uncompleted expense information of the present month is displayed on the income/expenditure information confirmation screen.

The editing accepting unit 126 accepts editing of the uncompleted expense information. Specifically, the editing accepting unit 126 displays, for example, an uncompleted input list screen when the number of pieces of uncompleted expense information displayed on the income/expenditure information confirmation screen is pushed via the operation unit 12. FIG. 18 shows an example of the uncompleted input list screen according to the present embodiment. Three pieces of uncompleted expense information are displayed on FIG. 18.

For example, on the uncompleted input list screen shown in FIG. 18, uncompleted expense information of 1,100 yen whose expense item is unknown is displayed for December 2 as uncompleted expense information. When the uncompleted expense information is selected via the operation unit 12, the display control unit 116 displays an expense information input screen to accept editing of the uncompleted expense information. In this case, the display control unit 116 displays an input screen in which a part of the input information of the uncompleted income/expenditure information, which has been already inputted, is inputted on the display unit 13.

On the uncompleted input list screen shown in FIG. 18, uncompleted expense information whose expense item and the amount of the expense are unknown and whose image data is stored is displayed for December 3. When an image display button is selected via the operation unit 12, for example, the display control unit 116 displays image data, and then displays the expense information input screen to accept editing of the uncompleted expense information.

On the uncompleted input list screen shown in FIG. 18, uncompleted expense information whose expense item and the amount of the expenses are unknown, and whose sound data is stored is displayed for December 4. For example, when a voice play button is selected via the operation unit 12, the control unit 11 outputs sound to a speaker (not shown) based on the sound data, and the display control unit 116 displays the expense information input screen to accept editing of the uncompleted expense information.

As described above, the mobile terminal 1 according to the present embodiment acquires expense information including partial input information from among a plurality of pieces of input information, and accepts editing of the expense information. Therefore, a user can edit expense information later if the user was not able to fill out all items of the expense information because of urgent business or the like. Since the partial information already inputted is displayed on the expense information input screen in this situation, the user can input uncompleted input contents of expense information using the input information. Thus, the mobile terminal 1 can solve the problem that a user cannot complete the input of all the items of expense information, and the problem that the user may forget to input them later.

### The Tenth Embodiment

### Manage Expense Information of a User of the Mobile Terminal 1 Belonging to an Organization

The expense information management system S according to the present embodiment is the same as the expense information management system S shown in the first embodiment except that the expense information management system S according to the present embodiment comprises a terminal 5, and a user who belongs to an organization manages expense information inputted by a user of the mobile terminal 1 who belongs to the organization. The organization herein is, for instance, a company, a group, or a part of organizations thereof

FIG. 19 shows a configuration of the expense information management system S according to the present embodiment. The expense information management system S according to the present embodiment further comprises the terminal 5, such as a personal computer. According to the present embodiment, the expense information management apparatus 2 further comprises an organization management unit 223, an expense item setting unit 224, a user management unit 225, and an expense information management unit 226.

For instance, the organization management unit 223 manages information of an organization. Specifically, the organization management unit 223 accepts information regarding the organization from the terminal 5 and stores the accepted information in the storage unit 21.

The expense item setting unit 224 accepts a setting of expense items used in the organization from the terminal 5. The expense item setting unit 224 accepts organization identification information for identifying the organization and expense item information for showing expense items used in the organization from the terminal 5. When the expense item setting unit 224 accepts the organization identification information and the expense item information, the expense item setting unit 224 stores them in the storage unit 21 in association with each other.

The user management unit 225 manages the user of the mobile terminal 1 who belongs to the organization. Specifically, the user management unit 225 accepts the organization identification information for identifying the organization and user identification information for identifying the user of the mobile terminal 1 from the mobile terminal 1. The user identification information herein is the name and the e-mail address of the user of the mobile terminal 1. The user management unit 225 stores the accepted user identification information in the storage unit 21 in association with the organization identification information. Here, the mobile terminal 1 of the user associated with the organization identification information receives expense items set by the expense item setting unit 224 from the expense information management apparatus 2 when expense information is inputted. The user selects any one of the expense items when the user inputs the expense information.

When the acquisition unit 221 receives the first expense information that is expense information whose purpose type is the first type and the user identification information of the user of the mobile terminal 1 from the mobile terminal 1, the acquisition unit 221 identifies the organization information associated with the user identification information. The acquisition unit 221 stores the identified organization information, the received expense information, and the user identification information in the storage unit 21 in association with each other as expense information for each organization.

The expense information management unit 226 manages expense information of the user of the mobile terminal 1 who belongs to the organization. For example, when the expense information management unit 226 accepts the organization identification information from the terminal 5, the expense information management unit 226 transmits the journalized result of the organization identification expense information associated with the organization identification information made by the journal unit 222 to the terminal 5. Further, upon receiving the user identification information of the mobile terminal 1 belonging to the organization from the terminal 5, the expense information management unit 226 aggregates the expense information for each organization associated with the user identification information for each expense item, and transmits the aggregated result to the terminal 5.

As described above, with the expense information management system S according to the present embodiment, the user of a terminal 5 can manage expense items of the organization and confirm expense information that users belonging to the organization have inputted with the mobile terminal 1, in a lump. Since the mobile terminal 1 accepts inputs of expense information of the user belonging to the organization, the problem that the input of expense information may be delayed because of a business trip or the like of users can be solved.

The present invention is described with the embodiments but the technical scope of the present invention is not limited to the scope described in the above embodiment. It is apparent for those skilled in the art that it is possible to make various changes and modifications to the embodiment. It is apparent from the description of the scope of the claims that the forms added with such changes and modifications are included in the technical scope of the present invention.

For example, instead of storing in the storage unit 14, the storage control unit 113 may directly store expense information in an apparatus such as a server 4 different from the mobile terminal 1 or a storage medium. The storage control unit 113 can write expense information in a storage unit provided in the server 4, read expense information from the storage unit, or transmit expense information from the storage unit to the expense information management apparatus 2 by transmitting a predetermined command to the server 4.

It should be noted that execution order of each process of action, procedure, step, stage, and the like of apparatus, system, program, and means shown in claims, specification, and drawings is not clearly indicated with the words such as “before” and “in advance,” and unless an output of a previous process is used in a later process, the process may be performed in any order. Regarding an action flow in the claims, specification, and drawings, even when described using “first,” “next” or the like, it does not mean that it is essential to be performed in the order.

As is apparent from the above description, with the embodiments of the present invention, the expense information management method, the expense information management system for managing expense information, and the mobile terminal can be implemented.

What is claimed is:

1. An expense information management method comprising:
acquiring expense information including a plurality of pieces of input information showing contents of expenses;
determining whether or not a purpose type showing a purpose of an expense is a first type, based on at least one piece of input information among the plurality of pieces of input information;
storing expense information corresponding to the expense determined to be the first type in a first storage unit; and
storing the expense information corresponding to the expense determined not to be the first type in a second storage unit that is different from the first storage unit.

2. The expense information management method according to claim 1, comprising:
displaying items used in determining the purpose type from among a plurality of input items corresponding to the plurality of pieces of input information as a plurality of candidates on a display unit;
acquiring a selected item from the plurality of candidates displayed on the display unit as a selection item;
acquiring (i) input information corresponding to the selection item and (ii) a purpose type corresponding to the selection item and the input information; and
storing the acquired selection item, the input information, and the purpose type in the second storage unit in association with each other as determination reference information,
wherein the determining includes determining whether or not the purpose type of the expense is the first type, based on the determination reference information.

3. The expense information management method according to claim 1, comprising:
acquiring position information showing positions where the expenses occurred;
storing the expense information and the position information in the second storage unit in association with each other; and
displaying the expense information containing the input information and being associated with a piece of position information identical to the acquired position information among the expense information stored in the second storage when at least one of the plurality of pieces of input information is acquired.

4. The expense information management method according to claim 3, wherein
the displaying includes displaying at least one piece of the expense information among the expense information stored in the second storage unit associated with the position information when the acquired position information shows the same position longer than a predetermined time.

5. The expense information management method according to claim 3, wherein
the displaying includes displaying at least one shop name corresponding to the position information when the acquired position information shows the same position longer than the predetermined time.

6. The expense information management method according to claim 3, wherein the input information includes date information showing a date when the expense occurred, the expense information management method further comprising:
calculating a predicted date of expense, which is when money is expected to be spent, based on the date information included in the input information of periodic expense information showing the expense information that periodically occurred among the plurality of pieces of expense information;
storing the periodic expense information, the predicted date of expense, and the position information in the second storage unit in association with each other; and
displaying the periodic expense information associated with the predicted date of expense and the position information on the display unit when position information acquired within a predetermined period around the predicted date of expense used in the acquiring the position information matches the position information associated with the predicted date of expense.

7. The expense information management method according to claim 2, wherein the input information includes date information showing the date when the expense occurred, the expense information management method further comprising:
calculating the predicted date of expense, which is when money is expected to be spent, based on the date information included in the input information of the periodic expense information showing the expense information that periodically occurred among the plurality of pieces of expense information; and
displaying the plurality of pieces of input information of the periodic expense information on the display unit when at least one of the plurality of pieces of input information of the expense information acquired within the predetermined period around the predicted date of expense matches at least one of the plurality of pieces of input information of the periodic expense information.

8. The expense information management method according to claim 2, comprising:
storing the expense information showing expenses that periodically occur acquired through an operation unit and an estimation period of the expense in the second storage unit in association with each other as periodic expense information; and
displaying the expense information associated with the periodic expense information on the display unit when at least one of the plurality of the pieces of input information is acquired, if (i) the periodic expense information stored in the second storage unit includes the input information, and (ii) the time of acquiring the input information is within a scheduled period.

9. The expense information management method according to claim 1, further comprising:
accepting editing of the expense information including partial input information from among the plurality of pieces of input information.

10. The expense information management method according to claim 1, wherein the input information includes one or more pieces of tag information classifying contents of the expense, the expense information management method further comprising:
aggregating the amount of money included in the expense information for each piece of the tag information.

11. The expense information management method according to claim 1, further comprising:
accepting input of the amount of a user's money;
calculating income and expenditure of a predetermined period;
storing the amount of the user's money; and
updating the stored amount of the user's money based on the calculated income and expenditure.

12. The expense information management method according to claim 11, further comprising:
calculating a difference between a newly accepted amount of the user's money and an updated amount of the user's money as adjusted unspecified money.

13. The expense information management method according to claim 1, further comprising:
generating a voucher image by making a photographing unit photograph a receipt; and
converting the voucher image into character information, wherein
the acquiring the expense information includes acquiring the character information as the input information, and
the determination includes determining that the purpose type of the expense information corresponding to the input information is the first type when the character information is acquired as the input information.

14. An expense information management system comprising:
a mobile terminal; and
an expense information management apparatus that can communicate with the mobile terminal, wherein the mobile terminal includes:
an expense information acquisition unit that acquires the expense information including a plurality of pieces of input information showing contents of an expense,
a determination unit that determines whether or not a purpose type showing a type of a purpose of the expense is the first type purpose based on at least one piece of input information among the plurality of pieces of input information, and
a storage control unit that stores first expense information showing the expense information corresponding to the expense determined to be the first type in a first storage in the expense information management apparatus, and stores the expense information corresponding to the expense determined not to be the first type in a second storage unit of the mobile terminal that is different from the first storage unit, and
the expense information management apparatus includes:
an acquisition unit that acquires the first expense information from the mobile terminal, and
a journal unit that journalizes the first expense information acquired by the acquisition unit.

15. The expense information management system according to claim 14, wherein the mobile terminal further includes:
a display control unit which displays items that are used for the determination unit to determine the purpose type on a display unit as a plurality of candidates among the plurality of input items corresponding to the plurality of pieces of input information; and
a reference information acquisition unit that acquires (i) an item as a selection item selected from among the plurality of candidates being displayed on the display unit, (ii) the input information corresponding to the selection item, and (iii) the purpose type corresponding to the selection item and the input information, wherein
the storage control unit stores the selection item set by the reference information acquisition unit, the input information, and the purpose type in the second storage unit as determination reference information in association with each other, and
the determination unit determines whether or not the purpose type of the expense information is the first type based on the determination reference information.

16. The expense information management system according to claim 15, wherein
the mobile terminal further comprises a position information acquisition unit that acquires position information showing a position where the expense occurred,
the storage control unit stores the expense information and the position information in the second storage unit in association with each other, and
the display control unit displays the expense information that includes the input information and is associated with the position information identical to the position information acquired by the position information acquisition unit among the expense information stored in the second storage unit when the expense information acquisition unit acquires at least one piece of the plurality of pieces of input information.

17. A mobile terminal comprising:
an expense information acquisition unit that acquires the expense information including a plurality of pieces of input information showing contents of an expense;
a determination unit that determines whether or not a purpose type showing the type of purpose of the expense is a first type, based on at least one piece of input information among the plurality of pieces of input information; and
a storage control unit that stores the expense information corresponding to the expense determined to be the first type in a first storage unit, and stores the expense information corresponding to the expenses determined not to be the first type in a second storage unit that is different from the first storage unit.

18. The mobile terminal according to claim 17, further comprising:
a display control unit that displays items that are used for the determination unit to determine the purpose type on the display unit as a plurality of candidates among the plurality of input items corresponding to the plurality of pieces of input information; and
a reference information acquisition unit that acquires (i) an item as a selection item selected from among the plurality of candidates displayed on the display unit, (ii) the input information corresponding to the selection item, and (iii) the purpose type corresponding to the selection item and the input information, wherein
the storage control unit stores the selection item set by the reference information acquisition unit, the input information, and the purpose type in the second storage unit as determination reference information in association with each other, and
the determination unit determines whether or not the purpose type of the expense is the first type, based on the determination reference information.

19. The mobile terminal according to claim 18, further comprising:
a position information acquisition unit that acquires position information showing a position where the expense occurred, wherein
the storage control unit stores the expense information and the position information in the second storage unit in association with each other,
the display control unit displays the expense information that includes the input information and is associated with the position information identical to the position information acquired by the position information acquisition unit from among the expense information stored in the second storage unit when the expense information acquisition unit acquires at least one of the plurality of pieces of input information.
